(19) United States
(12) Patent Application Publication
(10) Pub. No.: US 2018/0066612 A1
(43) Pub. Date: Mar. 8, 2018

(54) ALUMINUM PLATE AND EXHAUST GAS RECIRCULATION COOLER USING THE ALUMINUM PLATE

(71) Applicant: HYUNDAI MOTOR COMPANY, Seoul (KR)

(72) Inventors: Seok HA, Seoul (KR); Dong Young LEE, Goyang-si (KR); Sung Il YOON, Seoul (KR); Tae Ho JEONG, Yongin-si (KR)

(21) Appl. No.: 15/375,665

(22) Filed: Dec. 12, 2016

(30) Foreign Application Priority Data
Sep. 8, 2016 (KR) 10-2016-0115742

(51) Int. Cl. F02M 26/32; F02M 26/11

(52) U.S. Cl. CPC F02M 26/32; F02M 26/11

(57) ABSTRACT

An exhaust gas recirculation (EGR) cooler, which cools exhaust gas recirculated from an exhaust line to an intake line of an engine includes a housing provided with an internal space, tubes disposed in the internal space of the housing at a predetermined interval, and a pin disposed at an internal side of the tube, the pin having one side which is in contact with an internal surface of the tube, wherein a coolant flows between the housing and the tube, and exhaust gas flows into the internal side of the tube, and wherein the pin is formed of an aluminum-based material, and the aluminum-based material includes Mg and Ti at a predetermined ratio.

### CROSS-REFERENCE TO RELATED APPLICATION

This application claims the benefit of priority to Korean Patent Application No. 10-2016-0115742, filed with the Korean Intellectual Property Office on Sep. 8, 2016, the entire contents of which are incorporated herein by reference.

### TECHNICAL FIELD

The present disclosure relates to an exhaust gas recirculation (EGR) cooler, which recirculates exhaust gas from an exhaust line to an intake line for decreasing nitrogen oxide and granular material generated in exhaust gas, and cools the recirculated exhaust gas, and an aluminum plate used therein.

### BACKGROUND

Recently, regulations on exhaust gases have been enhanced and strict standard are applied to the emission quantity and quality of exhaust gas of an automobile.

Particularly, under the EURO-6, in a case of a diesel engine for a car, the quantity of NOx generated needs to be decreased to a level of 80 mg/km, and in this respect, automobile companies have adopted new technologies, such as EGR, LNT and SCR.

The exhaust gas recirculation (EGR) device includes a high pressure exhaust gas recirculation (HP-EGR) device, which recirculates exhaust gas and mixes the recirculated exhaust gas with compressed air, and a low pressure exhaust gas recirculation (LP-EGR) device, which recirculates exhaust gas at a rear end of a diesel particle filter (DPF) and mixes the recirculated exhaust gas with air at a front end of the turbocharger.

In this case, in order to cool the recirculated exhaust gas, an EGR cooler is disposed in an exhaust gas recirculation line, and the EGR cooler is generally made of a stainless material to prevent corrosion at a high temperature in the presence of condensate water.

However, the EGR cooler made of the stainless material is heavy, has a low heat transmission efficiency, and has poor molding properties, and all of the components are expensive. Accordingly, research on the EGR cooler, which has high heat transmission efficiency, excellent molding properties, and is made of aluminum, and of which components are relatively cheap, has been conducted.

Typically, A1100 that is based on pure aluminum (A1xxx) and A3003 that is based on aluminum-manganese (A3xxx) are used in a pin and a tube of a heat exchanger, which is a cooler, and a temperature of recirculated exhaust gas is about 550° C.

Further, corrosive ions, such as Cl—, SO42— and NO3—, exist as a component of condensate water, so that the aluminum-based pin or tube may be damaged in a high temperature environment and in a corrosive environment. In this respect, research on an aluminum sheet having high strength and high corrosion resistivity has been conducted.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to provide an aluminum plate, which maintains strength and has high corrosive resistivity in an environment, in which corrosive ions, such as Cl—, SO42— and NO3—, exist in condensate water, and a temperature of recirculated exhaust gas is about 550° C., and an EGR cooler using the same.

Exemplary embodiments of the present disclosure provide an exhaust gas recirculation (EGR) cooler, which cools exhaust gas recirculated from an exhaust line to an intake line of an engine, the EGR cooler including: a housing provided with an internal space; tubes disposed in the internal space of the housing at a predetermined interval; and a pin disposed at an internal side of the tube and having one side, which is in contact with an internal surface of the tube, where a coolant flows between the housing and the tube, and exhaust gas flows into the internal side of the tube, and the pin is formed of an aluminum-based material which includes Mg and Ti at a predetermined ratio.

The pin may include a cladding layer formed on a surface layer of an external side of the pin, and a core layer disposed inside the cladding layer, and the cladding layer may be an A4000-based aluminum alloy, and the core layer may be an aluminum alloy including Mg and Ti at a predetermined ratio.

The core layer may include one or more of Cu, Si, Fe, Zn, Mg, Mn, Ti and Al.

The core layer may include 0.5 to 0.6 wt % of Cu, 0.25 wt % or less of Si, 0.4 wt % or less of Fe, 0.1 wt % or less of Zn, 0.05 wt % or less of Mg, 1.0 to 1.3 wt % of Mn, 0.1 to 0.2 wt % of Ti, and the remaining portion may be Al.

In a process, in which the pin and the tube are brazed, a band layer formed of AlₓMn_{y}Si_{z} may be formed between the core layer and the cladding layer.

A temperature, at which the pin and the tube are brazed, may be within a range of 500° C. to 600° C.

Exemplary embodiments of the present disclosure provide an aluminum structure, including: tubes; and a pin disposed at an internal side of the tube and having one side which is in contact with an internal surface of the tube, in which the pin is formed of an aluminum-based material which includes Mg and Ti at a predetermined ratio.

The pin may include a cladding layer formed on a surface layer of an external side of the pin, and a core layer disposed inside the cladding layer, and the cladding layer may be an A4000-based aluminum alloy, and the core layer may include Mg and Ti with a predetermined ratio.

The core layer may include one or more of Cu, Si, Fe, Zn, Mg, Mn, Ti and Al.

The core layer may include 0.4 to 0.64 wt % of Cu, 0.6 to 0.84 wt % of Si, 0.4 to 0.6 wt % of Fe, 0.05 wt % or less of Zn, 0.3 to 0.4 wt % of Mg, 0.1 to 0.2 wt % of Ti and the remaining portion may be Al.

In a process, in which the tube and the pin are brazed, a band layer formed of AlₓMn_{y}Si_{z} may be formed between the core layer and the cladding layer.

A temperature, at which the tube and the pin are brazed, may be within a range of 500° C. to 600° C.

According to the exemplary embodiments of the present disclosure, the aluminum plate, or structure, has higher strength and improved corrosion resistivity at a high temperature and in an environment, in which corrosive ions exist, than those of the general aluminum plate of A3003.

Further, the EGR cooler using the aluminum plate may decrease its weight by the material characteristic of the aluminum-based material, improve heat exchange efficiency, and have a relatively high strength and high corrosive resistive characteristic to improve marketability and durability.

### BRIEF DESCRIPTION OF THE DRAWINGS

FIG. 1 is a perspective view of an EGR cooler according to exemplary embodiments of the present disclosure.

FIG. 2 is a cross-sectional view of the EGR cooler of FIG. 1 taken along line II-II of FIG. 1.

FIG. 3 is a table representing ingredients of an aluminum alloy material applied to a pin according to exemplary embodiments of the present disclosure.

FIG. 4 is a cross-sectional view illustrating a brazed state of a pin according to exemplary embodiments of the present disclosure.

FIG . 5A is a picture of a cross-section representing a corrosion experiment result of a pin according to the related art, and FIG. 5B is a picture of a cross-section representing a corrosion experiment result of a pin according to exemplary embodiments of the present disclosure.

FIGS. 6A to 6C are tables representing a corrosion experiment condition, a corrosion potential, and strength of a pin, respectively, according to exemplary embodiments of the present disclosure.

### DETAILED DESCRIPTION

Hereinafter, exemplary embodiments of the present disclosure will be described in detail with reference to the accompanying drawings.

In addition, the size and thickness of each configuration shown in the drawings may be arbitrarily shown for understanding and ease of description, but the present disclosure is not limited thereto, and the thicknesses of layers, films, panels and regions may be exaggerated for clarity.

A part irrelevant to the description will be omitted to clearly describe the present disclosure, and the same elements will be designated by the same reference numerals throughout the specification.

In a description below, names of constituent elements are discriminatingly used as “a first . . . ”, a second . . . ”, and the like, but this is for discriminating the same name of the constituent element, and the name of the constituent element is not limited to a relative order described.

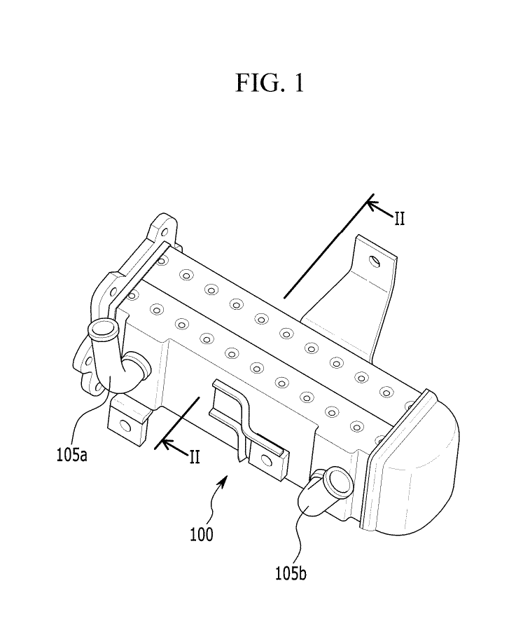

FIG. 1 is a perspective view of an EGR cooler according to exemplary embodiments of the present disclosure.

Referring to FIG. 1, an EGR cooler 100 is disposed so as to cool exhaust gas recirculated from an exhaust line to an intake line in an engine system.

The EGR cooler 100 cools recirculated exhaust gas by using a coolant, and the EGR cooler 100 is connected to a first coolant pipe 105a, through which the coolant flows in, and a second coolant pipe 105b, through which the coolant is discharged.

In exemplary embodiments of the present disclosure, a temperature of the exhaust gas passing through the EGR cooler 100 reaches about 550° C., and condensate water is generated according to a decrease in a temperature of exhaust gas by the EGR cooler 100, and the condensate water may include corrosive ions, such as Cl—, SO42— and NO3—.

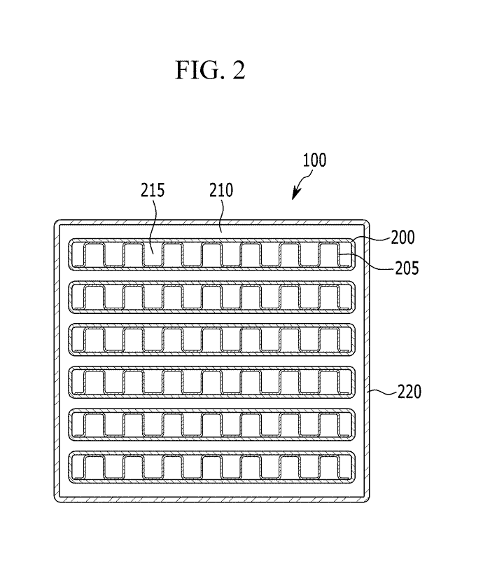

In exemplary embodiments of the present disclosure, compared to a general aluminum plate of A3003, the aluminum plate may have high strength and improved corrosion resistivity at a high temperature and in an environment, in which the corrosive ions exist by improving a material characteristic of aluminum used in a tube 200 (see FIG. 2) and a pin 205 (see FIG. 2) of the EGR cooler 100.

Further, the EGR cooler 100 using the aluminum plate may have a lower weight than a plate of other materials, such as steel, due to the material characteristics of the aluminum, may improve heat exchange efficiency and may have a relatively high strength and high corrosive resistive characteristic to improve marketability and durability.

FIG. 2 is a cross-sectional view of the EGR cooler of FIG. 1 taken along line II-II of FIG. 1.

A space is formed inside a housing 220, and the tubes 200 are arranged inside the housing 220 from an upper portion to a lower portion in the drawing at a predetermined interval, and the pin 205 having a zigzag form is disposed inside the tube 200.

An upper side of the pin 205 is brazed to an upper surface of an internal side of the tube 200, a lower side of the pin 205 is brazed to a lower surface of the internal side of the tube 200, and the pin 205 improves efficiency of heat transference between the recirculated exhaust gas and the coolant.

A coolant path 210, in which a coolant flows, is formed between an external surface of the tube 200 and the internal surface of the housing 220, an exhaust gas path 215, through which recirculated exhaust gas passes, is formed inside the tube 200, and the recirculated exhaust gas is cooled while being heat exchanged with the coolant through the pin 205 and the tube 200.

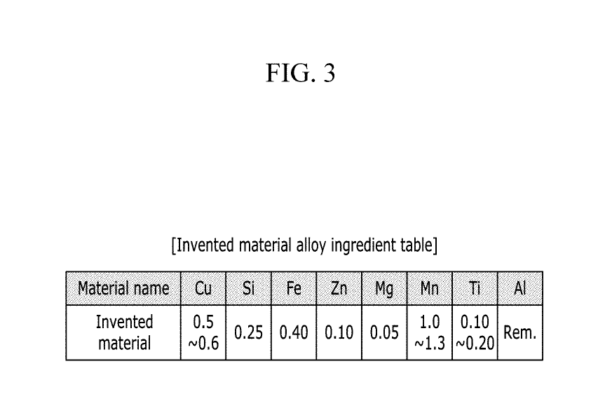

FIG. 3 is a table representing ingredients of an aluminum alloy material applied to a pin according to exemplary embodiments of the present disclosure.

Referring to FIG. 3, the pin 205 or the tube 200 used in the EGR cooler 102 includes one or more of Cu, Si, Fe, Zn, Mg, Mn, Ti and Al, and a mass ratio of each element is 0.5 to 0.6 wt % of CU, 0.25 wt % or less of Si, 0.4 wt % or less of Fe, a maximum of 0.1 wt % of Zn, 0.05 wt % or less of Mg, 1.0 to 1.3 wt % of Mn, 0.1 to 0.2 wt %, of Ti and a remaining portion is Al.

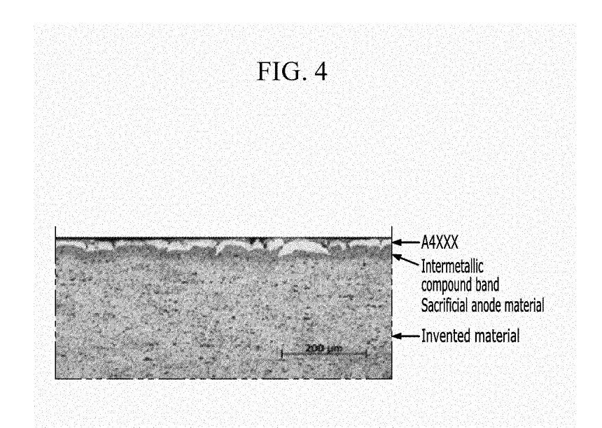

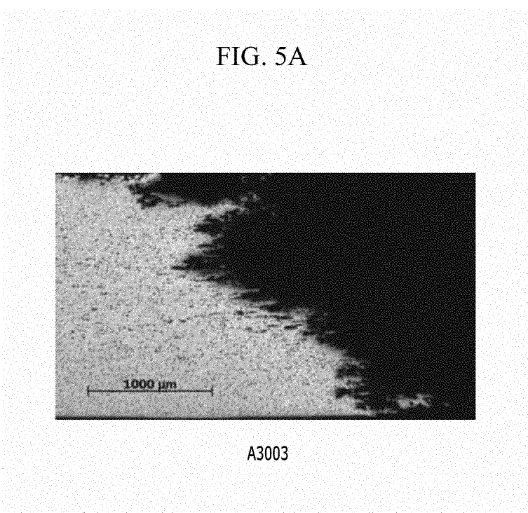

FIG. 4 is a cross-sectional view illustrating a brazed state of a pin according to exemplary embodiments of the present disclosure.

The pin 205 is generally formed of three layers, and includes a core layer formed of the material of the present disclosure at a center thereof, and cladding layers formed on both surfaces of the core layer.

An A4000-based aluminum alloy is used in the cladding layer, and the core layer is formed of the material of the present disclosure.

In exemplary embodiments of the present disclosure, it is possible to affect an age-hardening effect by an extraction of MgSi by adding a magnesium (Mg) ingredient to the core layer.

Further, it is possible to improve corrosion resistivity by adding an ingredient of Ti, and the addition of the ingredient of Ti to the aluminum alloy may change a corrosion progress from a localized corrosion to a lateral corrosion, thereby effectively restricting through-corrosion.

Further, when the material of the present disclosure is manufactured in a multilayer structure (the core layer and the cladding layer), and then a brazing process is performed, a band formed of AlₓMn_{y}Si_{z} that is an intermetallic compound is formed inside a surface layer, and the band has an anode characteristic as compared to a base layer, so that the band serves as a sacrificial anode layer protecting the base layer.

A temperature, at which the tube and the pin are brazed, may be within a range of 500° C. to 600° C.

FIG . 5A is a picture of a cross-section representing a corrosion experiment result of a pin according to the related art, and FIG. 5B is a picture of a cross-section representing a corrosion experiment result of a pin according to exemplary embodiments of the present disclosure.

Referring first to FIG. 5A, FIG. 5A shows an experiment result that when the existing A3000 material is exposed to a corrosive environment, the A3000 material is locally penetrated. However, FIG. 5B shows an experiment result that a surface of the material, or a material, according to the present disclosure is partially thin, but the material according to the present disclosure is not penetrated.

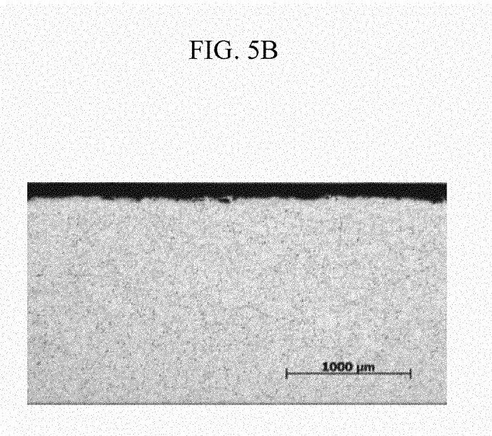

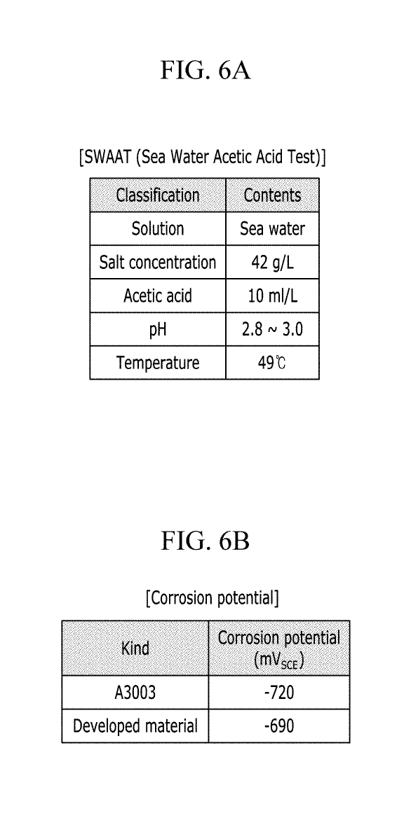

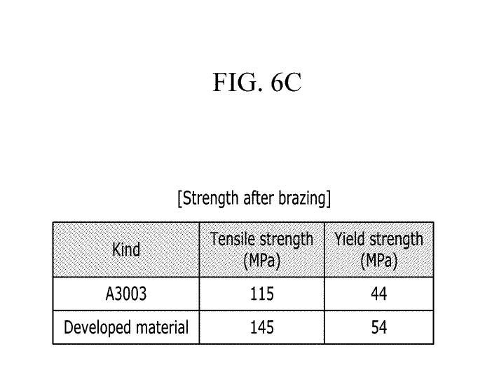

FIGS. 6A to 6C are tables representing a corrosion experiment condition, a corrosion potential, and strength of the pin, respectively, according to exemplary embodiments of the present disclosure.

FIG. 6A represents a sea water acetic acid test (SWAAT) method, in which acetic acid is added to artificial sea water and PH is adjusted to a predetermined value (2.8 to 3), and a specimen is exposed at a predetermined temperature for a predetermined time.

Referring to FIG. 6B, corrosion potential of A3003 is −720, and corrosion potential of the developed material is −690, so that it can be seen that the developed material has improved resistivity to the corrosion.

Further, referring to FIG. 6C, A3003 has a tensile strength of 115 MPa and a yield strength of 44 MPa, and the developed material of the present disclosure has tensile strength of 145 MPa and yield strength of 54 MPa, such that both tensile strength and yield strength of the developed material are improved .

While this disclosure has been described in connection with what is presently considered to be exemplary embodiments, it is to be understood that the disclosure is not limited to the disclosed embodiments. On the contrary, it is intended to cover various modifications and equivalent arrangements included within the spirit and scope of the appended claims.

What is claimed is:

1. An exhaust gas recirculation (EGR) cooler, which cools exhaust gas recirculated from an exhaust line to an intake line of an engine, the EGR cooler comprising:
a housing provided with an internal space;
tubes disposed in the internal space of the housing at a predetermined interval; and
a pin disposed at an internal side of the tube, the pin having one side which is in contact with an internal surface of the tube,
wherein a coolant flows between the housing and the tube, and exhaust gas flows into the internal side of the tube, and
wherein the pin is formed of an aluminum-based material, and the aluminum-based material includes Mg and Ti at a predetermined ratio.

2. The EGR cooler of claim 1, wherein the pin includes a cladding layer formed on a surface layer of an external side of the pin, and a core layer disposed inside the cladding layer,
the cladding layer is an A4000-based aluminum alloy, and
the core layer is an aluminum alloy including Mg and Ti at a predetermined ratio.

3. The EGR cooler of claim 2, wherein the core layer is an aluminum alloy including one or more of Cu, Si, Fe, Zn, Mg, Mn, Ti and Al.

4. The EGR cooler of claim 3, wherein the core layer is an aluminum alloy including 0.5 to 0.6 wt % of Cu, 0.25 wt % or less of Si, 0.4 wt % or less of Fe, 0.1 wt % or less of Zn, 0.05 wt % or less of Mg, 1.0 to 1.3 wt % of Mn, 0.1 to 0.2 wt % of Ti and the remaining portion of the core layer is formed of Al.

5. The EGR cooler of claim 4, wherein in a process in which the pin and the tube are brazed, a band layer formed of AlₓMn_{y}Si_{z} is formed between the core layer and the cladding layer.

6. The EGR cooler of claim 5, wherein a temperature, at which the pin and the tube are brazed, is within a range of 500° C. to 600° C.

7. An aluminum plate, comprising:
tubes; and
a pin disposed at an internal side of the tube, the pin having one side which is in contact with an internal surface of the tube,
wherein the pin is formed of an aluminum-based material, and the aluminum-based material includes Mg and Ti at a predetermined ratio.

8. The aluminum plate of claim 7, wherein the pin includes a cladding layer formed on a surface layer of an external side of the pin, and a core layer disposed inside the cladding layer,
the cladding layer is an A4000-based aluminum alloy, and
the core layer is an aluminum alloy including Mg and Ti at a predetermined ratio.

9. The aluminum plate of claim 8, wherein the core layer is an aluminum alloy including one or more of Cu, Si, Fe, Zn, Mg, Mn, Ti and Al.

10. The aluminum plate of claim 9, wherein the core layer is an aluminum alloy including 0.4 to 0.64 wt % of Cu, 0.6 to 0.84 wt % of Si, 0.4 to 0.6 wt % of Fe, 0.05 wt % or less of Zn, 0.3 to 0.4 wt % of Mg, 0.1 to 0.2 wt % of Ti and the remaining portion is formed of Al.

11. The aluminum plate of claim 10, wherein in a process, in which the tube and the pin are brazed, a band layer formed of AlₓMn_{y}Si_{z} is formed between the core layer and the cladding layer.

12. The aluminum plate of claim 11, wherein a temperature, at which the tube and the pin are brazed, is within a range of 500° C. to 600° C.
